(19) United States
(12) Patent Application Publication
(10) Pub. No.: US 2013/0290124 A1
(43) Pub. Date: Oct. 31, 2013

(54) DATA DELIVERY OPTIMIZATION VIA AN AUCTION SYSTEM

(71) Applicants: Edward Drake, Stevenson Ranch, CA (US); Arnaud Robert, Simi Valley, CA (US)

(72) Inventors: Edward Drake, Stevenson Ranch, CA (US); Arnaud Robert, Simi Valley, CA (US)

(73) Assignee: DISNEY ENTERPRISES, INC., Burbank, CA (US)

(21) Appl. No.: 13/457,057

(22) Filed: Apr. 26, 2012

(51) Int. Cl. G06Q 30/08

(52) U.S. Cl. 705/26.3

(57) ABSTRACT

An auction set of publisher parameters is composed. In addition, the auction set of publisher parameters is sent to an auction engine that provides a subset of the auction set of publisher parameters to one or more of a plurality of content network delivery providers. A selected bid based upon a bid selection process that evaluates a bid from each of the one or more of the plurality of content delivery network providers based upon the auction set of publisher parameters is received from the auction engine.

### BACKGROUND

1. Field

This disclosure generally relates to the field of data content. More particularly, the disclosure relates to the delivery of data content.

2. General Background

Content publishers and/or content distributors, hereafter referred to as content publishers, are entities that may publish various forms of media content such as movies, television shows, news, music, live concerts, or the like to end-users. For example, a content publisher such as a film studio or an online distributor may wish to deliver a movie to a large audience by streaming the movie to a video on demand service. To help facilitate the delivery of the media to the end-users, content publishers may wish to utilize a content delivery network (“CDN”). The CDN is a network that includes a plurality of computing devices positioned at various nodes in the distribution network such that each node may maintain a copy of the media, or a link to the media. The CDN may then deliver the media to the end-users from those nodes.

Further, a CDN provider may provide a content publisher with access to the CDN so that the content publisher may deliver large volumes of media content to end-users via said CDN. As a result, content publishers may manage and deliver large quantities of data to the end-users without having to directly invest in delivery infrastructure. The CDNs may provide massive storage and bandwidth to deliver high concurrency with high quality of service (“QoS”). The cost inferred by CDN providers for utilization of the CDNs may vary dramatically at any given time as a result of broad fluctuations in CDN resource utilization; accordingly the fees charged by CDN providers to content publishers may vary. For example, a CDN may have heavy demand for bandwidth when a new movie is published for video on demand services for the first few days after release. During such peak times, consumption demand may be so high that a content publisher may have to utilize multiple CDN providers to ensure adequate coverage.

Currently, content publishers have to establish individual relationships with each CDN provider. The CDN providers typically offer pricing structures that scale with usage, for example based on storage, resulting network traffic, and consumption patterns. Content publishers may also leverage multiple CDN providers to distribute the same media in order to optimize the delivery of such media to a broad set of end users. However, the content publisher has no mechanism for efficiently managing which CDN provider is most economical to utilize at any given point in time, present or future. As a result, a selected CDN provider may be overburdened and is not as cost effective or as reliable as it would be during times of less consumption demand.

### SUMMARY

In one aspect of the disclosure, a computer program product is provided. The computer program product includes a computer readable medium having a computer readable program stored thereon. The computer readable program when executed on a computer causes the computer to compose an auction set of publisher parameters for content delivery of a set of data. In addition, the computer readable program when executed on the computer causes the computer to send the auction set of publisher parameters from a content publisher to an auction engine that provides a subset of the auction set of publisher parameters to one or more of a plurality of content network delivery providers. The computer readable program when executed on the computer also causes the computer to receive, from the auction engine, a selected bid based upon a bid selection process that evaluates a bid from each of the one or more of the plurality of content delivery network providers based upon the auction set of publisher parameters.

In another aspect of the disclosure, a process is provided. The process composes an auction set of publisher parameters for content delivery of a set of data. In addition, the process sends the auction set of publisher parameters from a content publisher to an auction engine that provides a subset of the auction set of publisher parameters to one or more of a plurality of content network delivery providers. The process also receives, from the auction engine, a selected bid based upon an automatic bid selection process that evaluates, with a processor, a bid from each of the one or more of the plurality of content delivery network providers based upon the auction set of publisher parameters.

In yet another aspect of the disclosure, a system is provided. The system includes a processor that composes an auction set of publisher parameters for content delivery of a set of data, sends the auction set of publisher parameters to an auction engine that provides a subset of the auction set of publisher parameters to one or more of a plurality of content network delivery providers, and receives, from the auction engine, a selected bid based upon an automatic bid selection process that evaluates a bid from each of the one or more of the plurality of content delivery network providers based upon the auction set of publisher parameters.

In another aspect of the disclosure, a computer program product is provided. The computer program product includes a computer readable medium having a computer readable program stored thereon. The computer readable program when executed on a computer causes the computer to receive, from an auction engine, a subset of an auction set of publisher parameters established by a content publisher for content delivery of a set of data. Further, the computer readable program when executed on the computer causes the computer to send a bid to the auction engine. In addition, the computer readable program when executed on the computer causes the computer to receive a notification from the auction engine upon selection of the bid. The selection of the bid is based upon a bid selection process that evaluates a bid from each of one or more of the plurality of content delivery network providers based upon the auction set of publisher parameters.

In yet another aspect of the disclosure, a process is provided. The process receives, from an auction engine, a subset of an auction set of publisher parameters established by a content publisher for content delivery of a set of data. Further, the process sends a bid to the auction engine. In addition, the process receives a notification from the auction engine upon selection of the bid. The selection of the bid is based upon an automatic bid selection process that evaluates, with a processor, a bid from each of one or more of the plurality of content delivery network providers based upon the auction set of publisher parameters.

In another aspect of the disclosure, a system is provided. The system includes a processor configured to receive, from an auction engine, a subset of an auction set of publisher parameters established by a content publisher for content delivery of a set of data, send a bid to the auction engine, and receive a notification from the auction engine upon selection of the bid. The selection of the bid is based upon an automatic bid selection process that evaluates a bid from each of one or more of the plurality of content delivery network providers based upon the auction set of publisher parameters.

In one aspect of the disclosure, a computer program product is provided. The computer program product includes a computer readable medium having a computer readable program stored thereon. The computer readable program when executed on a computer causes the computer to receive, at an auction engine, an auction set of publisher parameters for content delivery of a set of data from a content publisher. Further, the computer readable program when executed on the computer causes the computer to provide, from the auction engine, a subset of the auction set of publisher parameters to one or more of a plurality of content network delivery providers. In addition, the computer readable program when executed on the computer causes the computer to receive, at the auction engine, a bid from each of the one or more of the plurality of content network delivery providers. The computer readable program when executed on the computer also causes the computer to tabulate, at the auction engine, a score for each bid according to a plurality of weighting factors such that each weighting factor corresponds to each publisher parameter in the auction set of publisher parameters. Further, the computer readable program when executed on the computer causes the computer to select a bid according to a highest score. In addition, the computer readable program when executed on the computer causes the computer to provide notification to a corresponding content delivery network provider associated with the selected bid.

In yet another aspect of the disclosure, a process is provided. The process receives, at an auction engine, an auction set of publisher parameters for content delivery of a set of data from a content publisher. Further, the process provides, from the auction engine, a subset of the auction set of publisher parameters to one or more of a plurality of content network delivery providers. In addition, the process receives, at the auction engine, a bid from each of the one or more of the plurality of content network delivery providers. The process also tabulates, at the auction engine, a score for each bid according to a plurality of weighting factors such that each weighting factor corresponds to each publisher parameter in the auction set of publisher parameters. Further, the process automatically selects, with a processor, a bid according to a highest score. In addition, the process provides notification to a corresponding content delivery network provider associated with the selected bid.

In another aspect of the disclosure, a system is provided. The system includes a processor configured to receive, at an auction engine, an auction set of publisher parameters for content delivery of a set of data from a content publisher, provide, from the auction engine, a subset of the auction set of publisher parameters to one or more of a plurality of content network delivery providers, receive, at the auction engine, a bid from each of the one or more of the plurality of content network delivery providers, tabulate, at the auction engine, a score for each bid according to a plurality of weighting factors such that each weighting factor corresponds to each publisher parameter in the auction set of publisher parameters, automatically select a bid according to a highest score, and provide notification to a corresponding content delivery network provider associated with the selected bid.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a system that may be utilized to perform data delivery optimization via an auction system.

FIG. 2 illustrates an auction configuration.

FIG. 3 illustrates a graphical user interface (“GUI”) that may display the publisher parameters.

FIG. 4 illustrates a process that may be utilized by the content publisher illustrated in FIG. 2 to provide publisher parameters for a bid selection determination to the auction engine illustrated in FIGS. 1 and 2.

FIG. 5 illustrates a process that may be utilized by the auction engine illustrated in FIGS. 1 and 2 to determine a bid selection.

FIG. 6 illustrates a process that may be utilized by a CDN provider to send a bid to the auction engine illustrated in FIGS. 1 and 2.

### DETAILED DESCRIPTION

An automated auction system may be utilized to allow a content publisher to make CDN providers aware of upcoming storage and traffic requirements. In other words, a content publisher may project the size of the data and its anticipated consumption by end users. The CDN providers may then each evaluate their respective ability to provide content delivery based on the forecasted requirements of the content publisher. The various CDN providers may then provide bids to the automated auction system. As an example, a bid may stipulate a fee for the service, a list of features included in the service, an expiration date/time of the bid, and/or the like.

In one aspect, the automated auction system may have built-in logic that allows it to select a winning bid. Such logic may utilize parameters provided by the content publisher to the automated auction system. For example, a content publisher may set an automated threshold of what is acceptable for each feature, e.g., a maximum price. The set of content publisher parameters may be called the ask. The automated action system may then utilize its built-in logic to automatically determine which bids of the CDN providers, if any, meet the ask, i.e., the acceptable requirements of the content publisher. The automated auction system may then determine which of those CDN providers is the winning bid based on a scoring system and/or may send the acceptable bids to the content publisher for a final decision. Further, the automated auction system may provide a notification of the winning bid to the CDN provider with the winning bid.

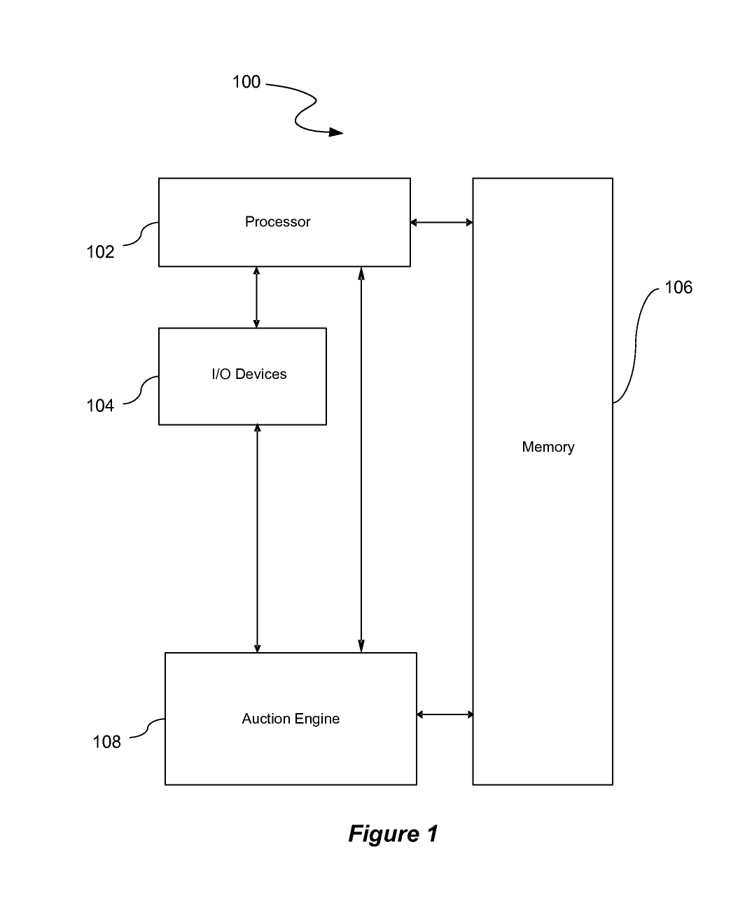

FIG. 1 illustrates a system 100 that may be utilized to perform data delivery optimization via an auction system. In one aspect, the system 100 is implemented utilizing a general purpose computer or any other hardware equivalents. Thus, the system 100 comprises a processor 102, a memory 106, e.g., random access memory (“RAM”) and/or read only memory (ROM), an auction engine 108 that performs the workflow of the auction system, and various input/output devices 104, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). In one aspect, the auction engine 108 is implemented as a module. Various other configurations for the auction engine 108 may be utilized.

It should be understood that the auction engine 108 may be implemented as one or more physical devices that are coupled to the processor 102. For example, the auction engine 108 may include a plurality of modules. Alternatively, the auction engine 108 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor 102 in the memory 106 of the system 100. As such, the auction engine 108 (including associated data structures) of the present disclosure may be stored on a computer readable medium, e.g., RAM memory, magnetic or optical drive or diskette and the like.

The system 100 may be utilized to implement any of the configurations herein. In another aspect, the processor 102 is the auction engine 108. Accordingly, in such an aspect, an auction engine 108 that is separate from the processor 102 is unnecessary. FIG. 1 provides an example of an implementation of an auction system. However, the auction system is not limited to any particular model and may be implemented with similar and/or different components from this example.

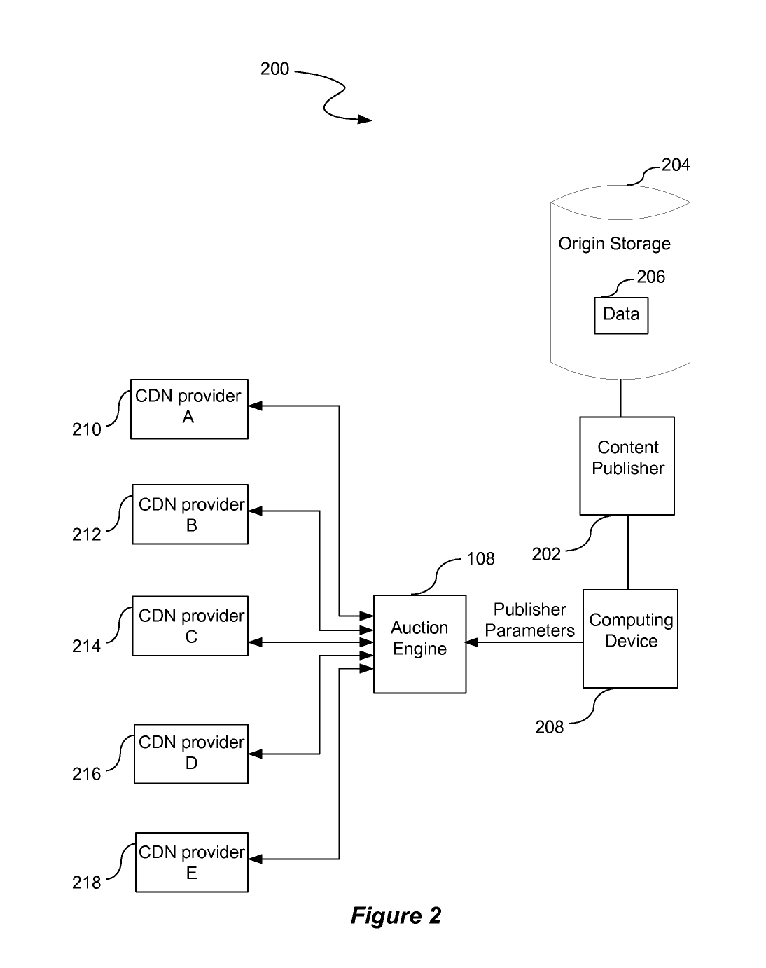

The auction engine 108 of the system 100 illustrated in FIG. 1 may interact with various entities to perform an auction for content delivery. FIG. 2 illustrates an auction configuration 200. The auction configuration 200 includes the auction engine 108 illustrated in FIG. 1 that interacts with a content publisher 202. The content publisher 202 may have access to an origin storage 204 that includes a set of data 206. The set of data may include media such as movies, television shows, music, and/or the like. Although a single content publisher 202 is illustrated, multiple content publishers may interact with the auction engine 108. Further, the content publisher 202 may include multiple entities that each interact with the auction engine 108.

Further, the content publisher may interact with the auction engine 108 through a computing device 208. The computing device may be a personal computer (“PC”), laptop, smartphone, tablet device, set top box, or the like. The computing device 208 may be utilized by the content publisher 202 to input publisher parameters to the auction engine 108. For example, the publisher parameters may include a publisher projected set of storage requirements for the set of data, a publisher projected set of traffic requirements for the set of data, a QoS level guarantee, a reduced latency guarantee, a set of security requirements, a set of geographical requirements, a cost restriction, a service level agreement (“SLA”), a price threshold, and/or the like, and a list of preferred CDN providers. The terms QoS and SLA are defined as understood in the literature of data delivery over networks. Further, the content publisher 202 may select a subset of the publisher parameters that the auction engine 108 is allowed to provide to CDN providers. The remaining publisher parameters would not be provided to the CDN providers.

For example, the content publisher 202 may indicate that a publisher projected set of storage requirements for the set of data, a publisher projected set of traffic requirements for the set of data, a QoS level guarantee, a reduced latency guarantee, a set of security requirements, a set of geographical requirements, a cost restriction, and an SLA should be provided to the CDN providers. The remaining price threshold would not be provided to the CDN providers. For instance, the price threshold may be a reserve price, i.e., a maximum price that a bid has to meet. The content publisher 202 may not want the CDN providers to be aware of that reserve price during bidding.

In one aspect, the auction engine 108 may provide a notification to a CDN provider that a bid provided by the CDN provider has not met the reserve price. In another aspect, such notification may only inform the CDN provider that the bid has not met the reserve price without disclosing the reserve price. The CDN provider may then be given an opportunity to adjust its bid to attempt to meet the reserve price.

Further, the configuration 200 includes a plurality of CDN providers, e.g., a first CDN provider A 210, a second CDN provider B 212, a third CDN provider 214, a fourth CDN provider D 216, and a fifth CDN provider E 218. In one aspect, the CDN providers are unaware of other bids provided by the remaining CDN providers. Accordingly, each CDN provider interacts with the auction engine 108 based upon the information that the respective CDN provider has about its own capabilities and features. As a result, practical federation of resources between otherwise competing CDN providers may be achieved.

A particular CDN provider may have available storage space that meets the cost and space requirements of the content publisher 202 while another CDN provider may have the most cost effective backbone or last-mile capacity. Accordingly, each CDN provider may be able to win a bid for a project that most ideally matches its resource availability.

In another aspect, the auction engine 108 provides each CDN provider with the bids of the remaining CDN providers. As a result, each CDN provider may lower its respective bid and/or include improved features to compete with the other CDN providers.

In one aspect, the auction engine 108 may automatically modify the ask if no bid meets the ask. For example, the content publisher 202 may indicate a predetermined modification if no bid meets the ask. For instance, the content publisher may indicate that the price should automatically be reduced to fifty percent between the price of the ask and the price of the highest bid based upon no bid meeting the ask.

In another aspect, the auction engine 108 may modify the ask if no bid meets the ask based upon a manual input from the content publisher 202. For example, the auction engine 108 may send a message to the content publisher 202 indicating that no bid meets the ask and receive a message from the content publisher 202 indicating a modified ask.

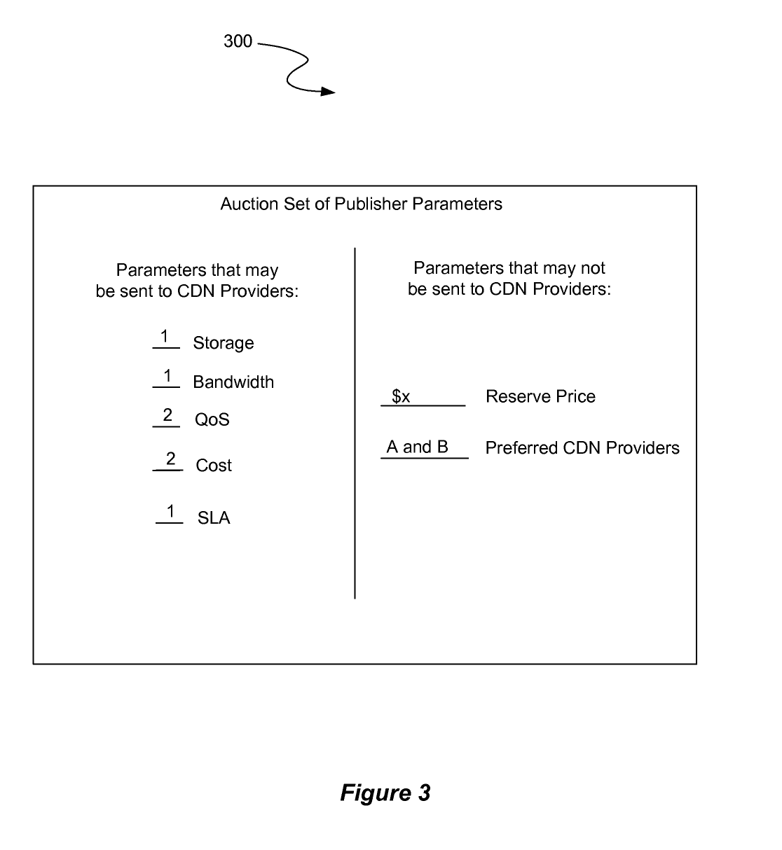

FIG. 3 illustrates a GUI 300 that may display the publisher parameters. For example, the GUI 300 may be operably connected to the computing device 208 of FIG. 2. The content publisher 202 may input various publisher parameters that may be sent to CDN providers and various publisher parameters that may not be sent to CDN providers. As an example, publisher parameters that may be sent to CDN Providers may include storage, bandwidth, QoS, cost, and SLA. In one aspect, the publisher parameters may be weighted by the content publisher. For instance, an indication of ‘1’ may indicate a higher weighting than an indication of ‘2’. The auction engine 108 illustrated in FIG. 2 may apply those weights to the bids provided by the CDN providers to tabulate a total score for each bid. The auction engine 108 may then rank the bids according to the total scores. Other types of weightings may be utilized. Further, as an example, publisher parameters that may not be sent to CDN Providers may include reserve price and preferred CDN providers.

For instance, the content publisher 202 may not want the CDN providers to be aware of the reserve price. The content publisher 202 may also indicate a list of preferred CDN providers, which indicates which CDN Providers the content publisher 202 is willing to accept bids from for a particular project. For instance, the content publisher 202 may want to only accept bids from particular CDN Providers from a particular geographic area, known capacity, and/or the like.

In one aspect, the content publisher 202 may establish a preference for manual bid selection upon at least two of the CDN providers having highest scores within a predetermined differential from each other. For example, two of the CDN providers may have the highest scores. If those scores are within a predetermined differential, e.g., five percent of each other, the auction engine 108 may send those bids to the content publisher 202 to perform a manual selection. The predetermined differential may be determined prior to the bidding process by the content publisher 202. Accordingly, the content publisher 202 may send the predetermined differential and an instruction for manual bid selection for the highest scores being within that predetermined differential to the auction engine 108 prior to bidding. In one aspect, manual bid selection may involve a human determination.

A variety of predetermined differentials may be utilized. The example of five percent is provided herein only as an example.

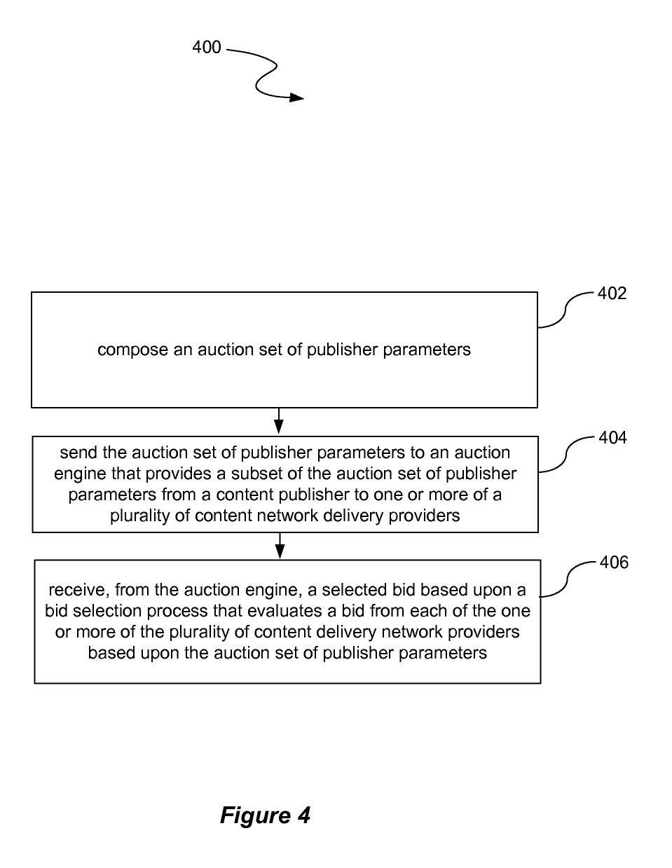

FIG. 4 illustrates a process 400 that may be utilized by the content publisher 202 illustrated in FIG. 2 to provide publisher parameters for a bid selection determination to the auction engine 108 illustrated in FIGS. 1 and 2. At a process bock 402, the process 400 composes an auction set of publisher parameters for content delivery of a set of data. In addition, at a process block 404, the process 400 sends the auction set of publisher parameters from a content publisher to an auction engine that provides a subset of the auction set of publisher parameters to one or more of a plurality of CDN providers. In one aspect, the auction set of publisher parameters may be manually provided. In another aspect, the auction set of publisher parameters may be automatically provided. In yet another aspect, the auction set of publisher parameters may be both manually provided and automatically provided. At a process block 406, the process 400 receives, from the auction engine, a selected bid based upon a bid selection process that evaluates a bid from each of the one or more of the plurality of CDN providers based upon the auction set of publisher parameters. In one aspect, the bid selection process may be automatic. As an example, a processor may be utilized to perform the bid selection process. In another aspect, the bid selection process may be manual. In another aspect, the bid selection process may be performed both automatically and manually.

In one aspect, the process 400 determines that a baseline set of publisher parameters for content delivery of the set of data is unfulfilled by each of a plurality of CDN providers. Such determination may be a trigger for the process 400 to proceed from the process block 402 through the process bock 406 as illustrated in FIG. 4. In another aspect, the process 400 determines that a baseline set of publisher parameters for content delivery of the set of data is fulfilled by one or more of the plurality of CDN providers, but also determines that additional and/or enhanced requirements may be met by allowing bidding to be performed. Such determination may be a trigger for the process 400 to proceed from the process block 402 through the process bock 406 as illustrated in FIG. 4. In yet another aspect, no trigger mechanism is utilized, i.e., the process 400 may proceed from the process block 402 through the process bock 406 as illustrated in FIG. 4 without any prior conditions being met.

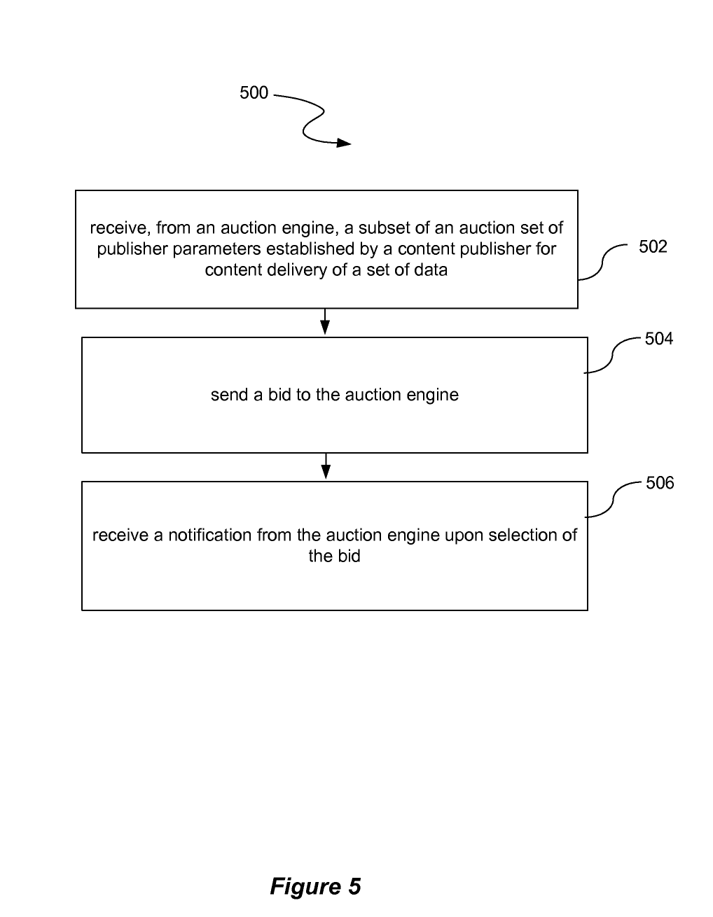

Further, FIG. 5 illustrates a process 500 that may be utilized by the auction engine 108 illustrated in FIGS. 1 and 2 to determine a bid selection. At a process block 502, the process 500 receives, from an auction engine, a subset of an auction set of publisher parameters established by a content publisher for content delivery of a set of data. Further, at a process block 504, the process 500 sends a bid to the auction engine. In addition, at a process block 506, the process 500 receives a notification from the auction engine upon selection of the bid. The selection of the bid is based upon a bid selection process that evaluates a bid from each of one or more of the plurality of CDN providers based upon the auction set of publisher parameters. In one aspect, the bid selection process may be automatic. As an example, a processor may be utilized to perform the bid selection process. In another respect, the bid selection process may be manual. In another aspect, the bid selection process may be performed both automatically and manually.

In one aspect, the process 500 determines that a baseline set of publisher parameters for content delivery of the set of data is unfulfilled by each of the plurality of CDN providers. Such determination may be a trigger for the process 500 to proceed from the process block 502 through the process bock 506 as illustrated in FIG. 5. In another aspect, the process 500 determines that a baseline set of publisher parameters for content delivery of the set of data is fulfilled by one or more of the plurality of CDN providers, but also determines that additional and/or enhanced requirements may be met by allowing bidding to be performed. Such determination may be a trigger for the process 500 to proceed from the process block 502 through the process bock 506 as illustrated in FIG. 5. In yet another aspect, no trigger mechanism is utilized, i.e., the process 500 may proceed from the process block 502 through the process bock 506 as illustrated in FIG. 5 without any prior conditions being met.

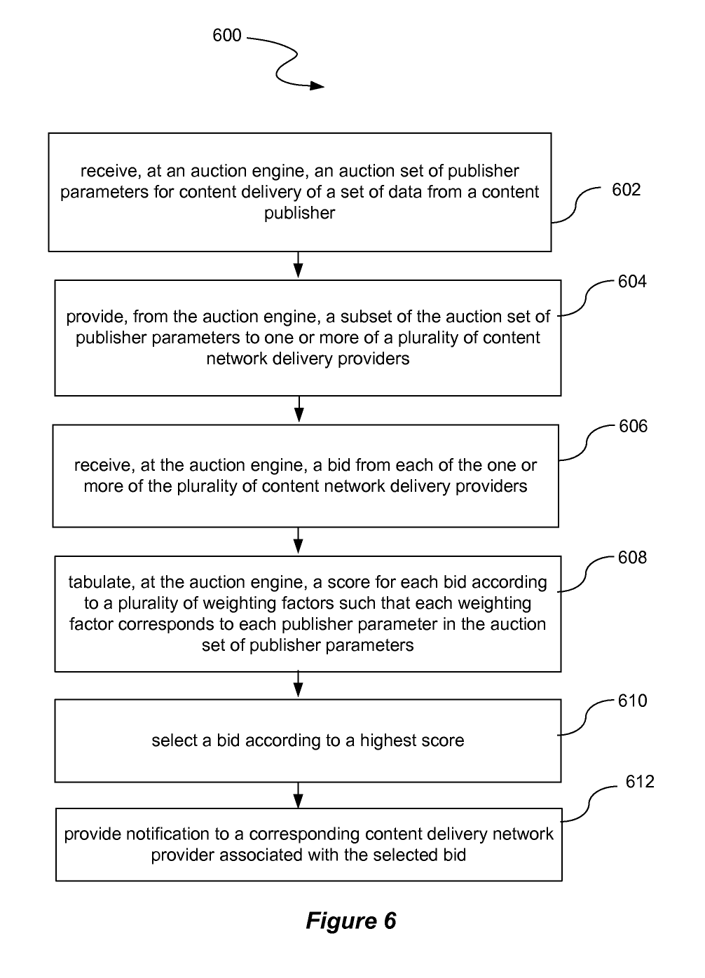

In addition, FIG. 6 illustrates a process 600 that may be utilized by a CDN Provider to send a bid to the auction engine 108 illustrated in FIGS. 1 and 2. At a process block 602, the process 600 receives, at an auction engine, an auction set of publisher parameters for content delivery of a set of data from a content publisher. Further, at a process block 604, the process 600 provides, from the auction engine, a subset of the auction set of publisher parameters to one or more of a plurality of CDN providers. In one aspect, the auction set of publisher parameters may be manually provided. In another aspect, the auction set of publisher parameters may be automatically provided. In yet another aspect, the auction set of publisher parameters may be both manually provided and automatically provided. In addition, at a process block 606, the process 600 receives, at the auction engine, a bid from each of the one or more of the plurality of CDN providers. At a process block 608, the process 600 also tabulates, at the auction engine, a score for each bid according to a plurality of weighting factors such that each weighting factor corresponds to each publisher parameter in the auction set of publisher parameters. Further, at a process block 610, the process 600 selects a bid according to a highest score. In one aspect, the bid selection process may be automatic. As an example, a processor may be utilized to perform the bid selection process. In another aspect, the bid selection process may be manual. In another aspect, the bid selection process may be performed both automatically and manually. In addition, at a process block 612, the process 600 provides notification to a corresponding CDN provider associated with the selected bid.

In one aspect, the process 600 determines that a baseline set of publisher parameters for content delivery of the set of data is unfulfilled by each of a plurality of CDN providers. Such determination may be a trigger for the process 600 to proceed from the process block 602 through the process bock 610 as illustrated in FIG. 6. In another aspect, the process 600 determines that a baseline set of publisher parameters for content delivery of the set of data is fulfilled by one or more of the plurality of CDN providers, but also determines that additional and/or enhanced requirements may be met by allowing bidding to be performed. Such determination may be a trigger for the process 600 to proceed from the process block 602 through the process bock 610 as illustrated in FIG. 6. In yet another aspect, no trigger mechanism is utilized, i.e., the process 500 may proceed from the process block 602 through the process bock 610 as illustrated in FIG. 6 without any prior conditions being met.

Any of the configurations provided herein may be utilized for unexpected changes in popularity or demand of content that involves an additional level of service to that of an accepted bid. For example, the auction engine 108 illustrated in FIGS. 1 and 2 may allow the content publisher 202 illustrated in FIG. 2 to extend the original ask as an extended ask in real-time. Accordingly, various CDN providers may bid for the surplus. The auction engine 108 may then automatically select an extended bid for the content publisher 202 based upon the extended ask. The content publisher 202 may establish the same or different publisher parameters from the original ask as the extended ask.

In another aspect, a temporal factor established by the content publisher 202 may be utilized by the auction engine 108 to determine a winning bid. For example, the auction engine 108 may select the bid that meets the ask and is the most quickly received as the winning bid. For instance, the content publisher 202 may have to obtain content delivery services very quickly and may not be able to wait for the auction engine 108 to determine which CDN provider better meets the ask than the others that meet the ask.

Accordingly, the various configurations provided for herein allow the content publisher 202 to establish a cost and resourcing requirement standard for a given set of content. Further, the various configurations allow CDN pricing and resource planning to be based on projected usage rather than on measured utilization. If the content publisher 202 did not forecast correctly, the CDN provider may utilize the measured utilization to correct any discrepancies.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a computer readable storage device having a computer readable program stored thereon, wherein the computer readable program when executed on a computer causes the computer to:
compose an auction set of publisher parameters for content delivery of a set of data;
send the auction set of publisher parameters from a content publisher to an auction engine that provides a subset of the auction set of publisher parameters to one or more of a plurality of content network delivery providers; and
receive, from the auction engine, a selected bid based upon a bid selection process that evaluates a bid from each of the one or more of the plurality of content delivery network providers based upon the auction set of publisher parameters.

2. The computer program product of claim 1, wherein the subset of the auction set of publisher parameters is selected by the content publisher.

3. The computer program product of claim 2, wherein the content publisher comprises a plurality of entities.

4. The computer program product of claim 1, wherein the subset of the auction set of publisher parameters is selected by a plurality of content publishers.

5. The computer program product of claim 1, wherein the subset of the auction set of publisher parameters is selected from the group consisting of a publisher projected set of storage requirements for the set of data, a publisher projected set of traffic requirements for the set of data, a quality of service level guarantee, a reduced latency guarantee, a set of security requirements, a set of geographical requirements, a cost restriction, a list of preferred content delivery network providers, and a service level agreement.

6. The computer program product of claim 1, wherein a remaining subset of the auction set of publisher parameters that is not provided to the plurality of content delivery network providers includes a price threshold.

7. The computer program product of claim 6, wherein the price threshold is a reserve price.

8. The computer program product of claim 1, wherein the computer is further caused to receive a plurality of weighting factors such that each weighting factor corresponds to each publisher parameter in the auction set of publisher parameters.

9. The computer program product of claim 8, wherein the auction engine tabulates a score for each of the plurality of content delivery network providers and automatically determines the selected bid according to a highest score.

10. The computer program product of claim 9, wherein the computer is further caused to establish a preference for manual bid selection upon at least two of the content delivery network providers having highest scores within a predetermined differential from each other.

11. The computer program product of claim 1, wherein the computer is further caused to enable a content delivery network provider feature such that a content publisher receives at least one additional parameter from a content delivery network provider in the plurality of content delivery network providers that is not present in the auction set of publisher parameters.

12. The computer program product of claim 1, wherein the computer is further caused to disable a content delivery network provider feature such that the content publisher does not receive at least one additional parameter from a content delivery network provider in the plurality of content delivery network providers that is not present in the auction set of publisher parameters.

13. The computer program product of claim 1, wherein the computer is further caused to receive a selection of the one or more of the plurality of content network delivery providers from the content publisher.

14. A method comprising:
composing an auction set of publisher parameters for content delivery of a set of data;
sending the auction set of publisher parameters from a content publisher to an auction engine that provides a subset of the auction set of publisher parameters to one or more of the plurality of content network delivery providers; and
receiving, from the auction engine, a selected bid based upon an automatic bid selection process that evaluates, with a processor, a bid from each of the one or more of the plurality of content delivery network providers based upon the auction set of publisher parameters.

15. The method of claim 14, wherein the subset of the auction set of publisher parameters is selected by the content publisher.

16. The method of claim 15, wherein the content publisher comprises a plurality of entities.

17. The method of claim 14, wherein the subset of the auction set of publisher parameters is selected by a plurality of content publishers.

18. The method of claim 14, wherein the subset of the auction set of publisher parameters is selected from the group consisting of a publisher projected set of storage requirements for the set of data, a publisher projected set of traffic requirements for the set of data, a quality of service level guarantee, a reduced latency guarantee, a set of security requirements, a set of geographical requirements, a cost restriction, a list of preferred content delivery network providers, and a service level agreement.

19. The method of claim 14, wherein a remaining subset of the auction set of publisher parameters that is not provided to the plurality of content delivery networks includes a price threshold.

20. The method of claim 19, wherein the price threshold is a reserve price.

21. The method of claim 14, further comprising receiving a plurality of weighting factors such that each weighting factor corresponds to each publisher parameter in the set of publisher parameters.

22. The method of claim 21, wherein the auction engine tabulates a score for each of the plurality of content delivery network providers and automatically determines the selected bid according to a highest score.

23. The method of claim 22, further comprising establishing a preference for manual bid selection upon at least two of the content delivery network providers having highest scores within a predetermined differential from each other.

24. The method of claim 14, further comprising enabling a content delivery network provider feature such that a content publisher receives at least one additional parameter from a content delivery network provider in the plurality of content delivery network providers that is not present in the set of publisher parameters.

25. The method of claim 14, further comprising disabling a content delivery network provider feature such that a content publisher does not receive at least one additional parameter from a content delivery network provider in the plurality of content delivery network providers that is not present in the set of publisher parameters.

26. The method of claim 14, further comprising receiving a selection of the one or more of the plurality of content network delivery providers from the content publisher.

27. A system comprising:
a processor that composes an auction set of publisher parameters for content delivery of a set of data, sends the auction set of publisher parameters from a content publisher to an auction engine that provides a subset of the auction set of publisher parameters to one or more of the plurality of content network delivery providers, and receives, from the auction engine, a selected bid based upon an automatic bid selection process that evaluates a bid from each of the one or more of the plurality of content delivery network providers based upon the auction set of publisher parameters.

28. A computer program product comprising a computer readable storage device having a computer readable program stored thereon, wherein the computer readable program when executed on a computer causes the computer to:
receive, from an auction engine, a subset of an auction set of publisher parameters established by a content publisher for content delivery of a set of data;
send a bid to the auction engine; and
receive a notification from the auction engine upon selection of the bid, the selection of the bid being based upon a bid selection process that evaluates a bid from each of one or more of the plurality of content delivery network providers based upon the auction set of publisher parameters.

29. The computer program product of claim 28, wherein the subset of the auction set of publisher parameters is selected by a content publisher.

30. The computer program product of claim 29, wherein the content publisher comprises a plurality of entities.

31. The computer program product of claim 28, wherein the subset of the auction set of publisher parameters is selected by a plurality of content publishers.

32. The computer program product of claim 28, wherein the subset of the auction set of publisher parameters is selected from the group consisting of a publisher projected set of storage requirements for the set of data, a publisher projected set of traffic requirements for the set of data, a quality of service level guarantee, a reduced latency guarantee, a set of security requirements, a set of geographical requirements, a cost restriction, a list of preferred content delivery network providers, and a service level agreement.

33. The computer program product of claim 28, wherein a remaining subset of the set of publisher parameters that is not provided to the plurality of content delivery network providers includes a price threshold.

34. The computer program product of claim 33, wherein the price threshold is a reserve price.

35. The computer program product of claim 28, wherein the computer is further caused to receive a plurality of weighting factors such that each weighting factor corresponds to each publisher parameter in the set of publisher parameters.

36. The computer program product of claim 35, wherein the auction engine tabulates a score for each of the plurality of content delivery network providers and automatically determines the bid selection according to a highest score.

37. The computer program product of claim 28, wherein the computer is further caused to send at least one additional parameter to the auction engine that is not present in the set of publisher parameters based upon enablement of a content delivery network provider feature.

38. A method comprising:
receiving, from an auction engine, a subset of an auction set of publisher parameters established by a content publisher for content delivery of a set of data;
sending a bid to the auction engine; and
receiving a notification from the auction engine upon selection of the bid, the selection of the bid being based upon an automatic bid selection process that evaluates, with a processor, a bid from each of one or more of the plurality of content delivery network providers based upon the auction set of publisher parameters

39. A system comprising:
a processor configured to receive, from an auction engine, a subset of an auction set of publisher parameters established by a content publisher for content delivery of a set of data, send a bid to the auction engine, and receive a notification from the auction engine upon selection of the bid, the selection of the bid being based upon an automatic bid selection process that evaluates a bid from each of one or more of the plurality of content delivery network providers based upon the auction set of publisher parameters.

40. A computer program product comprising a computer readable storage device having a computer readable program stored thereon, wherein the computer readable program when executed on a computer causes the computer to:
receive, at an auction engine, an auction set of publisher parameters for content delivery of a set of data from a content publisher;
provide, from the auction engine, a subset of the auction set of publisher parameters to one or more of a plurality of content network delivery providers;
receive, at the auction engine, a bid from each of the one or more of the plurality of content network delivery providers;
tabulate, at the auction engine, a score for each bid according to a plurality of weighting factors such that each weighting factor corresponds to each publisher parameter in the auction set of publisher parameters;
select a bid according to a highest score; and
provide notification to a corresponding content delivery network provider associated with the selected bid.

41. A method comprising:
receiving, at an auction engine, an auction set of publisher parameters for content delivery of a set of data from a content publisher;
providing, from the auction engine, a subset of the auction set of publisher parameters to one or more of a plurality of content network delivery providers;
receiving, at the auction engine, a bid from each of the one or more of the plurality of content network delivery providers;
tabulating, at the auction engine, a score for each bid according to a plurality of weighting factors such that each weighting factor corresponds to each publisher parameter in the auction set of publisher parameters;
automatically selecting, with a processor, a bid according to a highest score; and
providing notification to a corresponding content delivery network provider associated with the selected bid.

42. A system comprising:
a processor configured to receive, at an auction engine, an auction set of publisher parameters for content delivery of a set of data from a content publisher, provide, from the auction engine, a subset of the auction set of publisher parameters to one or more of a plurality of content network delivery providers, receive, at the auction engine, a bid from each of the one or more of the plurality of content network delivery providers, tabulate, at the auction engine, a score for each bid according to a plurality of weighting factors such that each weighting factor corresponds to each publisher parameter in the auction set of publisher parameters, automatically select a bid according to a highest score, and provide notification to a corresponding content delivery network provider associated with the selected bid.
